(19) United States
(12) Patent Application Publication
(10) Pub. No.: US 2006/0072106 A1
(43) Pub. Date: Apr. 6, 2006

(54) Image viewing method for microstructures and defect inspection system using it

(76) Inventors: Shigeru Matsui, Hitachinaka (JP); Kei Shimura, Mito (JP)

Correspondence Address: MCDERMOTT WILL & EMERY LLP, 600 13TH STREET, N.W., WASHINGTON, DC, 20005-3096, US

(21) Appl. No.: 11/243,188

(22) Filed: Oct. 5, 2005

(30) Foreign Application Priority Data
Oct. 5, 2004 (JP) 2004-292692

(51) Int. Cl. G01N 21/88

(52) U.S. Cl. 356/237.5

(57) ABSTRACT

A non-polarization beam splitter is used for splitting optical paths of an illumination system and an image formation system. MTF characteristics independent of an orientation of a pattern on a sample is obtained by illumination with a circularly-polarized light by combining a polarizer and a λ/4 plate. A partial polarizer is put in the image formation system immediately after the non-polarization beam splitter, and high-order diffraction lights are taken in with the maximum efficiency and the transmission efficiency of the zero-order light is controlled to improve high frequency part of MTF.

### BACKGROUND OF THE INVENTION

The present invention relates to an image viewing method for microstructures and a high-resolution microscope optical system for realizing the method, and more particularly, it relates to a high-resolution optical system to be used for observation and inspection of defects in a fine pattern, foreign matters on the pattern and the like in a manufacturing process of a semiconductor, a manufacturing process of a flat panel display or the like, and a defect inspection system using the optical system.

In a manufacturing process of a semiconductor, a manufacturing process of a flat panel display or the like, observation and inspection of defects in a fine pattern, foreign matters on the pattern and the like are performed using an optical microscope. In recent years, as the integration of a semiconductor device is improved, improvement of the performance of a microscope optical system is required.

As methods for improving the resolution of an optical microscope, there are a technique of shortening the wavelength of a light to be used for image formation, a technique of increasing numerical apertures (NA) of an objective lens, and a superresolution technique of raising high frequency part of a modulation transfer function (MTF) of an image formation system. Among them, the technique of shortening the wavelength and the technique of increasing the NA are direct methods, but on these methods, various restrictions are put in practice and therefore they are often impractical. For this reason, much attention is paid to a method in which microstructures can be observed in high contrast without changing the wavelength and the NA, that is, the superresolution technique of raising high frequency part of the MTF of an image formation system.

As an example of the superresolution technique, JP-A-2000-155099 discloses methods of improving the MTF by controlling the polarization of the light. There are disclosed a method in which a sample is illuminated with a linearly-polarized light and a reflected light from the sample is conducted to an image formation system through an analyzer; and a method in which a sample is illuminated with an elliptically-polarized light and only the linearly-polarized component of a reflected light from the sample, reflected on a polarizing beam splitter, is conducted to an image formation system. In the former method, the orientation of the linear polarization of the light illuminating the sample to a direction of a linear pattern on the sample and the orientation of the analyzer are optimized to control a ratio between the high-order diffraction lights and the zero-order diffraction light by the pattern on the sample. By decreasing the quantity of the zero-order light, the high frequency part of the MTF is improved, and the difference in light quantity between where the pattern exists and where the pattern does not exist, can be reduced. Thus, the fine pattern becomes easy to see, and the performance of the defect inspection using the observation image can be improved. Although the method has disadvantages that the efficiency of use of the light is low and the image is dark because a non-polarizing beam splitter must be used for splitting the optical path of the image formation system of the illumination system, a large MTF improvement effect can be obtained because a change in polarization remarkably appears at the time of reflection on the sample. In the latter method, by optimizing the orientation of the elliptically-polarized light illuminating the sample to a direction of a linear pattern on the sample, and the ellipticity of the polarization of the light, a similar MTF improvement effect can be obtained. The efficiency of use of the light can be higher than that of the system using illumination with the linearly-polarized light, and thus a bright image can be obtained. In this system, illumination with a linearly-polarized light can also be realized. In such a case, however, because no reflected light from the sample returns to the image formation system, an image can not be observed with the linearly-polarized light illumination that brings about the largest MTF improvement effect.

Of the general constructions of the systems for realizing the above method, FIGS. 4 and 5 show an example of the latter case wherein illumination with an elliptically-polarized light is used. A light emitted from a light source 8 reaches an aperture stop 11 through a concave mirror and a lens 9. Further, the light enters a polarizing beam splitter 15 through a lens, a wavelength selecting filter 12, and a field stop 13. A linearly-polarized light having passed the polarizing beam splitter 15 passes a λ/2 plate 16 and a λ/4 plate 17 to be converted into the elliptically-polarized light and incident on a sample 1 through an objective lens 20. A direction of the long axis of the elliptic polarization can be controlled by rotating the λ/4 plate 17, and the ellipticity of the elliptic polarization can be controlled by rotating the λ/2 plate 16. The light reflected on the sample 1 again enters the polarizing beam splitter 15 through the objective lens 20, the λ/4 plate 17, and the λ/2 plate 16. Only the s polarization component is reflected on the polarizing beam splitter 15 and then conducted to an image formation system made up of an imaging lens 30 and a zoom lens 50. In this system, when the angles of two wavelength plates are determined so that the sample 1 is illuminated with a circularly-polarized light, only the component that did not change in polarization when reflected on the sample surface, is reflected on the polarizing beam splitter 15 to be conducted to the image formation system. On the other hand, when the angles of two wavelength plates are determined so that the sample 1 is illuminated with the elliptically-polarized light, part of the component that changed in polarization when reflected on the sample 1, is also reflected on the polarizing beam splitter 15 to be conducted to the image formation system. In general, although a light diffracted by a linear pattern may change in polarization, the zero-order light does not change. Therefore, by illuminating with the elliptically-polarized light, the diffracted light component is enhanced and conducted to the image formation system. As a result, an image in which the high frequency part of the MTF has been improved can be obtained.

As other prior arts for improving high frequency part of the MTF with illuminating a sample with the circularly-polarized light, there are a method of disposing a polarizer on the illumination side, a λ/4 plate on the objective lens side, and an analyzer on the image formation side of a non-polarizing beam splitter having no polarization characteristics, as disclosed in JP-A-5-296842 or Applied Optics, vol.33, pp.1274-1278 (1994); and a method of disposing a λ/4 plate on the objective lens side and an analyzer on the image formation side of a partially-polarizing beam splitter having incomplete polarization characteristics, as disclosed in JP-A-2003-344306. Also in these prior arts using illumination with a circularly-polarized light, like the above-described method using illumination with an elliptically-polarized light, the principle of improvement of the high frequency part of the MTF is in conducting to the image formation side only the component having changed in polarization when reflected on the sample surface or components having changed in polarization when reflected on the sample surface, as much as possible.

The methods using illumination with a linearly-polarized light and with an elliptically-polarized light, described as prior arts, are effective methods that can improve the high frequency part of the MTF. To obtain a large MTF improvement effect, however, the orientation of the polarization of the illuminating light must be changed in accordance with the orientation of the pattern on the sample, and there is a problem that setting of conditions is complicated. In addition, in the case that patterns different in orientation exist together on the sample, there is a problem that it is hard to obtain the same MTF improvement effect for all the patterns. This is because the MTF improvement effect is not isotropic and it depends on the relation between the direction of the polarization of the illuminating light and the direction of the pattern on the sample. In the method of disposing the polarizer on the illumination side, the λ/4 plate on the objective lens side, and the analyzer on the image formation side of the non-polarizing beam splitter and illuminating the sample with the circularly-polarized light, although an isotropic MTF improvement effect can be obtained when the orientation of the analyzer on the image formation side is set parallel to the polarizer on the illumination side, the MTF improvement effect is adjustable in its intensity but not isotropic when the analyzer is in another state than the above. On the other hand, in the method of disposing the λ/4 plate on the objective lens side and the analyzer on the image formation side of the partially-polarizing beam splitter and illuminating the sample with the circularly-polarized light, although the effect of improving the high frequency part of the MTF is good in the point that the effect is isotropic, there is a problem that a large MTF improvement effect can not be obtained because the components not having changed in polarization when reflected on the sample (the most of which are regularly-reflected lights, that is, the zero-order light) are always conducted to the image formation optical system with substantially no loss.

### SUMMARY OF THE INVENTION

An object of the present invention is to provide a method by which a large MTF improvement effect can be obtained irrespective of the direction of a pattern on a sample, and in which the intensity of the improvement effect can be changed at need with keeping the isotropy of the MTF improvement effect.

To obtain an MTF improvement effect irrespective of the orientation of a pattern on a sample, the present invention provides a method of obtaining the MTF improvement effect under illumination with a circularly-polarized light. More specifically, a non-polarizing beam splitter is used for splitting an optical path between an illumination system and an image formation system; a light is caused to enter the non-polarizing beam splitter through a polarizer in the illumination system; a sample is illuminated with a circularly-polarized light by adding a λ/4 plate after permeation of the non-polarizing beam splitter; and a partially-polarizing plate is added to the image formation system immediately after the non-polarizing beam splitter. Because a component generated by changing in polarization when reflected on the sample is a circularly-polarized light having its rotational direction reverse to the polarization rotational direction of the circularly-polarized light not having changed in polarization, the component becomes a linearly-polarized light in the same orientation as that at the time of illumination after the component again passes through the λ/4 plate. The partially-polarizing plate is put parallel to the orientation of the linearly-polarized light so as to transmit the linearly-polarized light component in the orientation with the maximum efficiency. If the partially-polarizing plate substantially completely blocks the linearly-polarized light component caused by the component not having changed in polarization, a dark field image is obtained in which only its edges are highlighted and brightened and its flat portion is viewed darkly, and the maximum MTF improvement effect can be obtained. By providing some steps of partially-polarizing plates different in the degree of leak of a linearly-polarized light in the perpendicular direction, and changing over them, the MTF improvement effect can be controlled. In any of the control steps, the MTF improvement effect is isotropic irrespective of the orientation of the pattern on the sample.

According to the present invention, because an effect of improving high frequency part of the MTF can be isotropically obtained, high-resolution image observation irrespective of the direction of the pattern on the sample, and high-sensitive defect detection are possible. In addition, because the intensity of the effect of improving the high frequency part of the MTF can be controlled by changing at need with simple changeover the efficiency of conducting the component having reversed in rotational direction when reflected, (the regularly-reflected component, that is, the zero-order light component), of the lights reflected on the sample, to the image formation system, coping with more variable samples becomes possible.

Other objects, features and advantages of the invention will become apparent from the following description of the embodiments of the invention taken in conjunction with the accompanying drawings.

### BRIEF DESCRIPTION OF THE DRAWINGS

FIG. 1 is a view showing an embodiment of a defect inspection system according to the present invention;

FIG. 2 is a detailed view of an optical path splitting section in the defect inspection system according to the present invention;

FIG. 3 is a view showing another embodiment of a defect inspection system according to the present invention;

FIG. 4 is a view showing an example of constitution of an optical system of a prior art defect inspection system;

FIG. 5 is a view showing an example of constitution of an optical path splitting section in the prior art defect inspection system;

FIGS. 6A, 6B, 6C are representations for explaining image contrast;

FIGS. 7A, 7B are graphs for explaining frequency components included in an image; and

FIG. 8 is a block diagram showing a specific example of an image processing circuit.

### DETAILED DESCRIPTION OF THE EMBODIMENTS

Hereinafter, embodiments of the present invention will be described with reference to drawings. In the below drawings, the same functional components will be described with being denoted by the same numerical references.

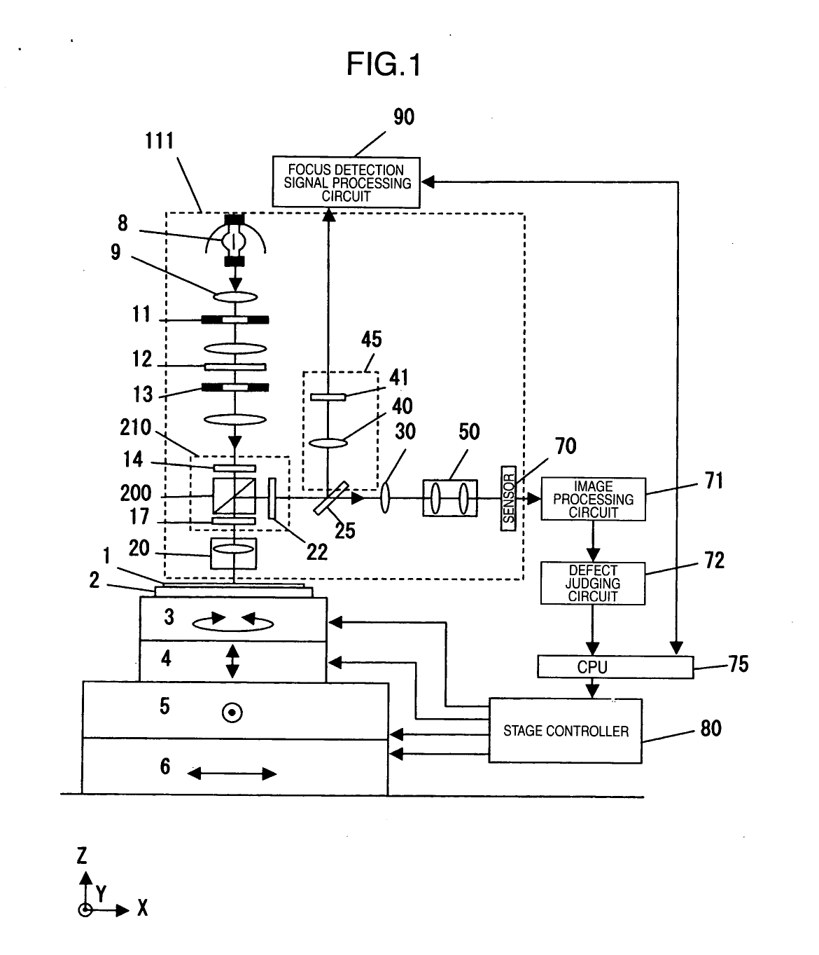

FIG. 1 shows an embodiment of an optical defect inspection system using an image viewing method for microstructures of the present invention. A sample 1 is sucked onto a chuck 2 by vacuum. The chuck 2 is mounted on a θ stage 3, a Z stage 4, a Y stage 5, and an X stage 6. An optical system 111 disposed above the sample 1 is for picking up an optical image of the sample 1 for inspection of an external view of a pattern formed on the sample 1. The optical system 111 is mainly made up of an illumination optical system, an image formation optical system for making and picking up an image of the sample 1, and a focus detection optical system 45. A light source 8 disposed in the illumination optical system is an incoherent light source, for example, a xenon lamp.

A light emitted from the light source 8 passes through an aperture of an aperture stop 11 via a lens 9, and further reaches a field stop 13 via a lens and a wavelength splitting filter 12. The wavelength splitting filter 12 is for restricting the illumination wavelength range so as to detect an image of the sample 1 with high resolution, in consideration of the spectral reflection factor of the sample 1. As the wavelength splitting filter 12, for example, an interference filter is disposed. The light having passed the field stop 13 enters an optical path splitting section 210.

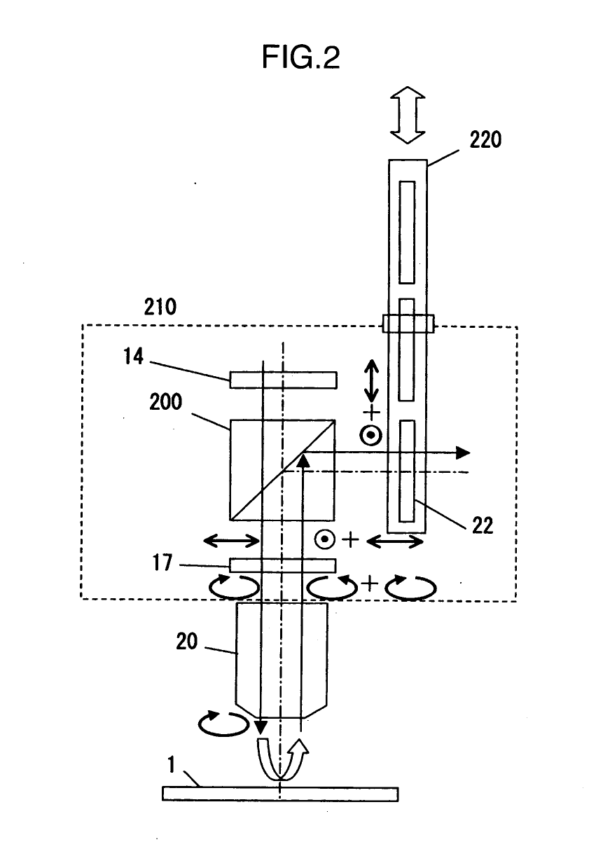

The optical path splitting section 210 is made up of a polarizer 14, a non-polarization beam splitter 200 substantially equal in characteristics between p and s polarizations, a λ/4 plate 17, and a partially polarizing plate 22. The optical path splitting section 210 separates an optical path of an illumination light from the light source 8 toward the sample 1, and an optical path from the sample 1 toward an image pickup device from each other. FIG. 2 shows a function of the optical path splitting section 210.

An illumination light (random polarized light) having entered the optical path splitting section 210 passes the polarizer 14 to be converted into a linearly-polarized light of p polarization, and then passes the non-polarization beam splitter 200. Further, the light is converted into a circularly-polarized light by the λ/4 plate 17, and then applied onto the sample 1 through an objective lens 20. The light applied onto the sample 1 is reflected, diffused, and diffracted on the sample 1. The light within the NA of the objective lens 20 again enters the objective lens 20, and then passes the λ/4 plate 17. Of the light reflected on the sample 1, the component reversed in rotational direction when reflected (the regularly-reflected component, that is, the zero-order light component) is converted into a linearly-polarized light of s polarization by the λ/4 plate 17. On the other hand, of the light reflected on the sample 1, the component not changed in rotational direction when reflected (the component generated by a change in polarization of the reflected light, that is, part of the high-order diffraction light) is converted into a linearly-polarized light of p polarization by the λ/4 plate 17. Those components are reflected by the non-polarization beam splitter 200, and then enters the partially polarizing plate 22. The partially polarizing plate 22 is disposed so as to transmit a light of p polarization with substantially no loss except the reflection/absorption loss inevitable in an optical element, and transmit only part of a light of s polarization. Thus, the component not changed in rotational direction when reflected (the component generated by a change in polarization of the reflected light, that is, part of the high-order diffraction light), of the light reflected on the sample 1, passes the partially polarizing plate 22 with the maximum efficiency, and only part of the component reversed in rotational direction when reflected (the regularly-reflected component, that is, the zero-order light component), of the light reflected on the sample 1, passes the partially polarizing plate 22. Because the reflected light component reflecting high spatial frequency information on the sample 1 is contained in the high-order diffraction light, the high spatial frequency component is emphasized and an MTF improvement effect can be obtained.

When only the component not changed in rotational direction when reflected (the component generated by a change in polarization of the reflected light, that is, part of the high-order diffraction light), of the light reflected on the sample 1, is conducted to the image formation optical system to form an image, as described in Applied Optics, vol.33, pp.1274-1278 (1994), the degree of emphasis on the image is isotropic to the pattern of every orientation. On the other hand, when a p polarization component caused by the component not changed in rotational direction when reflected (the component generated by a change in polarization of the reflected light, that is, part of the high-order diffraction light), of the light reflected on the sample 1, and an s polarization component caused by the component reversed in rotational direction when reflected (the regularly-reflected component, that is, the zero-order light component), of the light reflected on the sample 1, are combined by an analyzer (a polarization plate) whose orientation is disposed at an intermediate angle of p and s polarizations, the combination result changes in accordance with positive/negative of the difference in phase between the p and s polarizations. Therefore, if the pattern of a certain orientation is emphasized in the formed image, the pattern of an orientation perpendicular to the above pattern is suppressed in contrast. Thus, the MTF improvement effect is anisotropic. In the method of the present invention, however, the partially-polarizing plate is used so as to allow the p and s polarization components to pass without combining them in polarization. Therefore, when an image formed by the image formation system is detected by an image pickup device, the quantity of a light detected is the sum of the square of the amplitude of the p polarization component and the square of the amplitude of the s polarization component. Thus, such anisotropy of the MTF improvement effect as described above is not produced and the effect is always isotropic irrespective of the magnitude of the transmission efficiency of the s polarization component.

Now will be discussed a case wherein a stripe pattern of the contrast of 100% in which the density I changes on a sine wave by the place x as shown by the following equation is used as the sample 1 and an image of the object is formed by the image formation optical system.
I(x)=0.5+0.5'×cos (x)

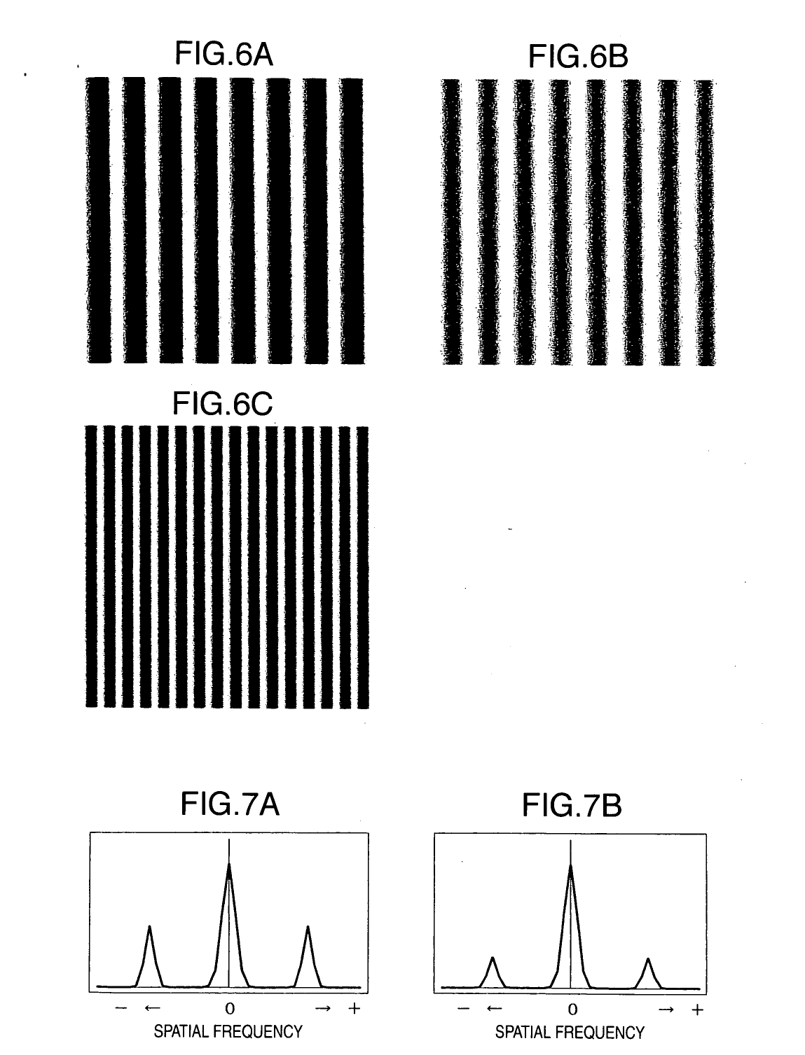

In this case, if the image formation characteristics of the image formation optical system is ideal, an image faithful to the object can be obtained as shown in FIG. 6A. In the spatial frequency component of this case, a ratio in intensity between the zero-order light (current component) and the ±1-order light (cos component) is 1:0.5. However, an image obtained by using a general image formation optical system is an image as shown in FIG. 6B lower in contrast than the image of FIG. 6A. The spatial frequency component of this case is as shown in FIG. 7B. As an image when a defect existing in such a stripe pattern is sensitively detected, it is generally known that such an image obtained in good contrast, that is, with sufficient resolution, as shown in FIGS. 6A and 7A, is suitable.

Comparing FIGS. 7A and 7B, it is understood that the zero-order light component of the spatial frequency components of the image bad in contrast as shown in FIG. 6B is relatively larger in intensity than the +1-order light component in comparison with a general image good in contrast. Therefore, by suppressing the component reversed in rotational direction when reflected (the regularly-reflected component, that is, the zero-order light component), of the light reflected on the sample 1, as described above, at the time of image formation, the contrast can be improved. At this time, however, the zero-order light should be adequately suppressed. In the spatial frequency component in a desired state in which the contrast has been improved, for example, when an image exhibits a change in density on a simple sine wave, the ratio between the intensity of the zero-order light and the intensity of the +1-order light should by about 1:0.5. If the rate of the zero-order light is decreased more than that when the zero-order light is suppressed, a structure having a spatial frequency not contained in the original object may appear on the image, and this may be an obstacle to defect inspection. For example, if the zero-order light is completely removed, as shown in FIG. 6C, a formed image is an image made from double spatial frequency components not contained in the original stripe pattern, largely different from the original image.

In zero-order light suppressing means, therefore, it is required that the degree of suppression of the zero-order light can be changed in accordance with the contrast characteristics of the original sample.

In this embodiment, a plurality of partially-polarizing plates 22 are provided that are different in transmission efficiency to s polarization. A partially-polarizing plate having a desired value of transmission efficiency to s polarization is selected by a partially-polarizing plate changeover mechanism 220, and disposed on the optical path in the image formation optical system. Thereby, the effect of improving high frequency part of the MTF can be controlled in accordance with a pattern to be inspected. Because such a partially-polarizing plate is simply a permeation element different from an optical path splitting element by which turnback of the optical path is produced by reflection, such as a beam splitter, taking in/out or changing over the partially-polarizing plate on the optical path in the image formation optical system is easy on accuracy.

The light having passed the partially-polarizing plate 22 forms an image of the sample 2 on a light receiving face of an image sensor 70 through the image formation optical system made up of the image lens 30 and the zoom lens 50. As the image sensor 70 used is a linear sensor, a TDI image sensor, an area sensor (a TV camera), or the like. Part of the reflected light from the sample is conducted to the focus detection optical system 45 by an optical splitting means 25 such as a dichroic mirror, so as to be used for signal detection for automatic focusing.

The imaging lens 40 brings the focus detection light form into an optical image having information on height of the sample 1 on a sensor 41. A signal of an output of the sensor is input to a focus detection signal processing circuit 90. The focus detection signal processing circuit 90 detects the quantity of shift between the height of the sample 1 and the focal position of the objective lens 20, and sends data of the focus shift quantity to a CPU 75. In accordance with the focus shift quantity, the CPU 75 instructs a stage controller 80 to drive the Z stage 4. The stage controller 80 then sends a predetermined pulse to the Z stage 4 and thereby automatic focusing is performed.

Image data of the optical image of the sample 1 detected by the image sensor 70 in the detection optical system is input to an image processing circuit 71 to be processed, and then judgment of a defect is made by a defect judgment circuit 72. The result is displayed on display means such as a display unit, and transmitted to an external storage/control machine such as a work station or a data server through communication means.

As a specific processing method of a series of image processing from the image sensor 70 to the defect judgment circuit 72 in which judgment of a defect is made from detected image data, for example, as described in JP-A-2-170279 or JP-A-3-33605, there are a method of performing by comparing corresponding image data of neighboring chips with each other; a method of comparing corresponding image data of neighboring chips with each other; a method of comparing image data of neighboring patterns with each other; a method of comparing design data and image data with each other; and so on.

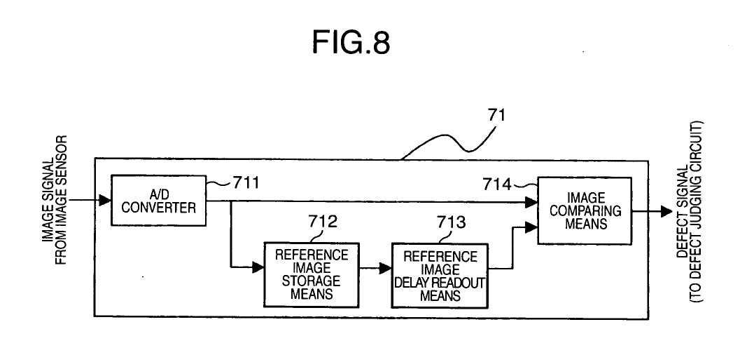

FIG. 8 shows a specific example of the image processing circuit 71. A detected light received by the image sensor 70 passes an A/D converter 711 to be converted into a digital signal, and then stored in reference image storage means 712. Of patterns having the same shape arranged continuously at regular intervals in directions of rows and columns on the sample 1, an image of the pattern just below the objective lens 20 and being currently picked up is referred to as a detection image, and an image of the pattern of the same shape neighboring the detection image and having been picked up immediately before the detection image is referred to as a reference image. Image comparing means 714 compares the detection image being currently picked up and the stored reference image in intensity of corresponding position, and outputs a defect signal in accordance with the intensity difference. In order to compare the outputs at the same position of the detection image and the reference image at the same time in the image comparing means 714, the output of the reference image storage means 712 is delayed by reference image delay readout means 713 by a fixed time corresponding to an interval between patterns on the sample 1 and then supplied to the image comparing means 714.

Movement of the sample 1 in XY directions is made by the stage controller 80 two-dimensionally controlling the movements of the X stage 6 and the Y stage 5. The θ stage 3 is used when θ alignment between a pattern formed on the sample 1 and the movement directions of the XY stages 6 and 5 is made.

In this embodiment, the light source 8 is an incoherent light source such as a xenon lamp. However, the light source 8 may be a coherent light source such as a laser light source. In this case, if the output light from the laser is initially a linearly-polarized light, the polarizer 14 in the illumination optical system can be omitted.

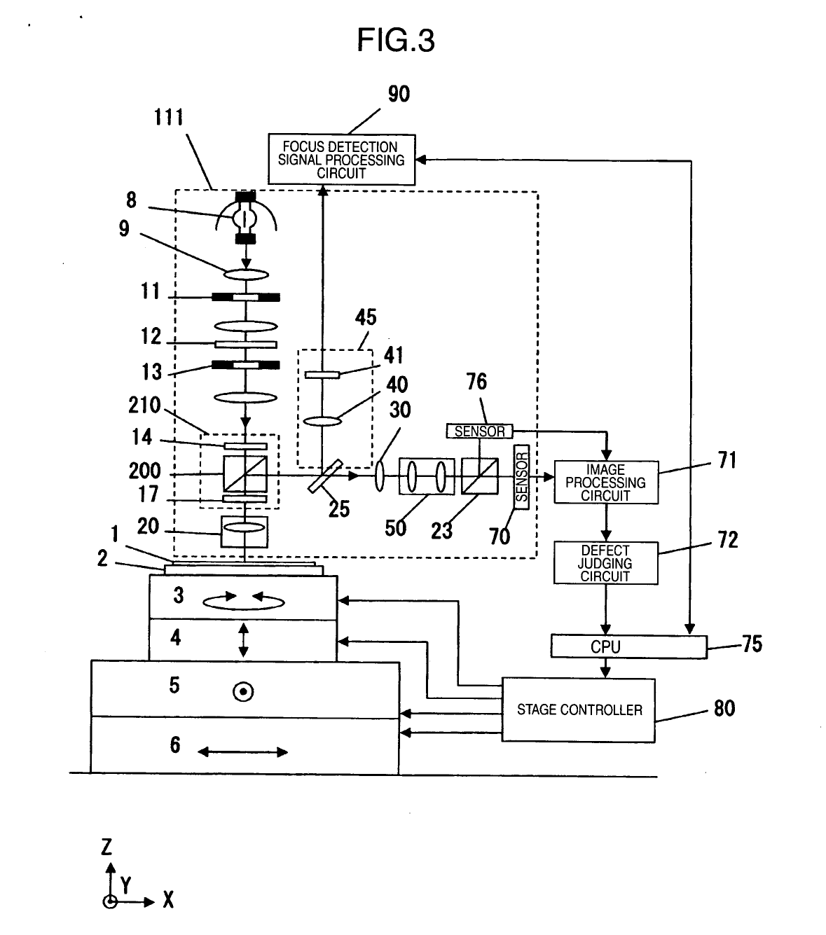

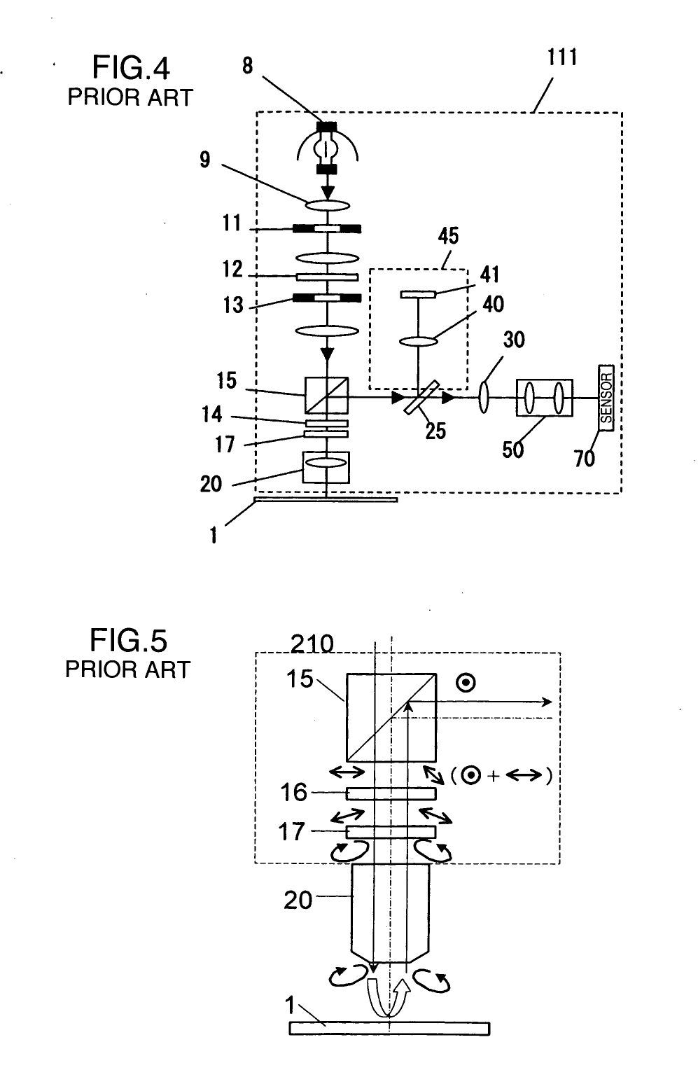

FIG. 3 shows another embodiment. The feature that an illuminating light from the light source 8 is incident on the sample 1; a light reflected/diffused/diffracted from the sample 1 returns to the non-polarization beam splitter; and a light is reflected on the non-polarization beam splitter to the image formation optical system side, is the same as that of the embodiment shown in FIG. 1. In this embodiment, of the light reflected on the sample 1, both of the component reversed in rotational direction at the time of reflection and having been converted by the λ/4 plate 17 into a linearly-polarized light of s polarization (the regularly-reflected component, that is, the zero-order light component) and the component not changed in rotational direction at the time of reflection and having been converted by the λ/4 plate 17 into a linearly-polarized light of p polarization (the component generated by a change in polarization of the reflected light, that is, part of the high-order diffraction light) are conducted to the image formation optical system after reflected on the non-polarization beam splitter 17, and images are formed by the works of the imaging lens 30 and the zoom lens 50. In this embodiment, a polarization beam splitter 23 is put after the zoom lens 23. Of the light reflected on the sample 1, the component reversed in rotational direction at the time of reflection and having been converted by the λ/4 plate 17 into a linearly-polarized light of s polarization (the regularly-reflected component, that is, the zero-order light component) is reflected on the polarization beam splitter 23, and the component not changed in rotational direction at the time of reflection and having been converted by the λ/4 plate 17 into a linearly-polarized light of p polarization (the component generated by a change in polarization of the reflected light, that is, part of the high-order diffraction light) passes the polarization beam splitter 23. These split two optical components form images of the sample 1 on the respective image sensors 70 and 76 at the same magnification.

Both of image data of the optical images of the sample 1 detected by the image sensors 70 and 76 are input to the image processing circuit 71, in which the respective image data are multiplied by different proper coefficients and then summed. At this time, by multiplying the component not changed in rotational direction at the time of reflection and having been converted by the λ/4 plate 17 into a linearly-polarized light of p polarization (the component generated by a change in polarization of the reflected light, that is, part of the high-order diffraction light), of the light reflected on the sample 1, by a larger coefficient, the summed image data contains the component more than the other component, and thereby an effect of improving the high frequency part of the MTF can be obtained. If each of the component reversed in rotational direction at the time of reflection and having been converted by the λ/4 plate 17 into a linearly-polarized light of s polarization (the regularly-reflected component, that is, the zero-order light component), of the light reflected on the sample 1, and the component not changed in rotational direction at the time of reflection and having been converted by the λ/4 plate 17 into a linearly-polarized light of p polarization (the component generated by a change in polarization of the reflected light, that is, part of the high-order diffraction light), of the light reflected on the sample 1, is detected individually, the contrast improvement effect to the pattern on the sample 1 is isotropic irrespective of the pattern orientation. Thus, an isotropic contrast improvement effect can be obtained in the image after summing. In addition, by changing the coefficient to be multiplied, the intensity of the improvement effect can be easily controlled. The constitutions and operations for automatic focusing and defect inspection in this embodiment are the same as those of the embodiment shown in FIG. 1, and thus the description thereof is omitted.

It should be further understood by those skilled in the art that although the foregoing description has been made on embodiments of the invention, the invention is not limited thereto and various changes and modifications may be made without departing from the spirit of the invention and the scope of the appended claims.

1. An image viewing method for microstructures which observes a fine pattern formed on a surface of a sample with the aid of a light, the method comprising:
a step of applying an illuminating light in a substantially circularly-polarized state onto the sample through an objective lens; and
a step of forming a sample image in which from a light reflected on the sample, there is changed a ratio between circularly-polarized light components in two rotational directions of the reversed direction to and the same direction as the rotational direction of a polarized plane in the illuminating light,
whereby there is formed the image in which the contrast of the fine pattern formed on the surface of the sample is emphasized irrespective of a direction of the pattern.

2. The image viewing method for microstructures, according to claim 1, further comprising a step of passing the light reflected on the sample through a partially-polarizing plate that transmits a linearly-polarized light in a specific oscillation direction at a high transmittance and transmits a linearly-polarized light in an oscillation direction perpendicular to the above oscillation direction at a transmittance lower than the above transmittance.

3. The image viewing method for microstructures, according to claim 2, wherein the method further comprises a step of passing the light reflected on the sample, through a λ/4 plate to be converted into a linearly-polarized light, and said partially-polarizing plate transmits a linearly-polarized light caused by a circular polarization component not changed in rotational direction when reflected on the sample, at a high transmittance.

4. The image viewing method for microstructures, according to claim 1, further comprising:
a step of separating circular polarization components in two rotational directions of the reverse direction to and the same direction as a rotational direction of a plane of polarization of the illuminating light, to separate optical paths;
a step of picking up images of the sample by the respective polarization components with independent image sensors; and
a step of combining the picked-up two images with changing the ratio in intensity.

5. A defect inspection system comprising:
a sample stage on which a sample is to be placed;
a non-polarization beam splitter;
an optical system that comprises a light source and causes a linearly-polarized light to enter said non-polarization beam splitter;
a λ/4 plate that converts said linearly-polarized light having passed said non-polarization beam splitter, into a circularly-polarized light;
an objective lens that applies the circularly-polarized light from said λ/4 plate onto the sample placed on said sample stage, and causes a reflected light from the sample to enter said λ/4 plate again;
a partially-polarizing plate disposed in an optical path of the reflected light from the sample emitted from said non-polarization beam splitter;
an image formation optical system that a light having passed said partially-polarizing plate enters to form an image of the sample;
an image sensor that picks up the image of the sample formed by said image formation optical system; and
a defect detecting section that detects a defect on the sample by comparing the image picked up by said image sensor with an image stored in advance.

6. The defect inspection system according to claim 5, wherein said partially-polarizing plate is oriented so as to transmit a linearly-polarized light caused by a circular polarization component not changed in rotational direction when reflected on the sample, at a high transmittance.

7. The defect inspection system according to claim 6, further comprising a plurality of partially-polarizing plates different in transmission efficiency to a linearly-polarized light caused by a circular polarization component reversed in rotational direction when reflected on the sample; and partially-polarizing plate changeover means that selectively disposes one of said plurality of partially-polarizing plates on an optical path.

8. A defect inspection system comprising:
a sample stage on which a sample is to be placed;
a non-polarization beam splitter;
an optical system that comprises a light source and causes a linearly-polarized light to enter said non-polarization beam splitter;
a λ/4 plate that converts said linearly-polarized light having passed said non-polarization beam splitter, into a circularly-polarized light;
an objective lens that applies the circularly-polarized light from said λ/4 plate onto the sample placed on said sample stage, and causes a reflected light from the sample to enter said λ/4 plate again;
an image formation section that is disposed in an optical path of the reflected light from the sample emitted from said non-polarization beam splitter, and separately forms sample images caused by circular polarization components in two rotational directions of the reverse direction to and the same direction as a rotational direction of a plane of polarization of the illuminating light for the sample;
first and second image sensors that pick up the respective two sample images by said image formation section;
an image processing section that forms a sample image obtained by summing and combining images picked up by said first and second image sensors, at different rates; and
a defect detecting section that detects a defect on the sample by comparing said combined sample image with an image stored in advance.

9. The defect inspection system according to claim 8, wherein said image processing section sums the sample image caused by the circular polarization component in the same rotational direction as the rotational direction of the plane of polarization of the illuminating light for the sample at a rate higher than that of the sample image caused by the circular polarization component in the reverse direction.

10. The defect inspection system according to claim 8, wherein said image formation section comprised an image formation optical system disposed in the optical path of the reflected light from the sample emitted from said non-polarization beam splitter; and a polarization beam splitter disposed on a stage subsequent to said image formation optical system.
